(19) United States
(12) Patent Application Publication
(10) Pub. No.: US 2011/0304515 A1
(43) Pub. Date: Dec. 15, 2011

(54) Antenna Coupled Radiation Sensor

(75) Inventors: William H. Wellman, Goleta, CA (US); Michael A. Gritz, Goleta, CA (US)

(73) Assignee: Raytheon Company, Waltham, MA (US)

(21) Appl. No.: 12/814,209

(22) Filed: Jun. 11, 2010

(51) Int. Cl. H01Q 1/00; G01J 5/02

(52) U.S. Cl. 343/720; 250/338.1; 250/340; 250/215

(57) ABSTRACT

According to one embodiment, a radiation sensor comprises a first pixel and a second pixel. The first pixel comprises a first plurality of antenna elements, a first photodetector, and one or more first feed lines coupling the first plurality of antenna elements to the first photodetector. The second pixel comprises a second plurality of antenna elements, a second photodetector, and one or more second feed lines coupling the second plurality of antenna elements to the second photodetector. The second pixel is an off-axis pixel. Signals feeding each of the second plurality of antenna elements are varied such that an effective radiation pattern of the second plurality of antenna elements is reinforced in a desired direction and suppressed in an undesired direction.

### TECHNICAL FIELD OF THE DISCLOSURE

This disclosure generally relates to imaging sensors, and more particularly, to an antenna-coupled radiation sensor.

### BACKGROUND OF THE DISCLOSURE

Radiation imaging devices, such as digital sensors or cameras, are useful for many applications, including scientific equipment, surveillance equipment, targeting equipment, and other military applications. These devices may detect radiation such as infrared radiation or microwave radiation.

### SUMMARY OF THE DISCLOSURE

According to one embodiment, a radiation sensor comprises a first pixel and a second pixel. The first pixel comprises a first plurality of antenna elements, a first photodetector, and one or more first feed lines coupling the first plurality of antenna elements to the first photodetector. The second pixel comprises a second plurality of antenna elements, a second photodetector, and one or more second feed lines coupling the second plurality of antenna elements to the second photodetector. The second pixel is an off-axis pixel. Signals feeding each of the second plurality of antenna elements are varied such that an effective radiation pattern of the second plurality of antenna elements is reinforced in a desired direction and suppressed in an undesired direction.

Some embodiments of the present disclosure may provide numerous technical advantages. A technical advantage of one embodiment may include the ability to align pixel antenna gain with optical field angle for optimal detection of incoming radiation. A technical advantage of one embodiment may also include the capability to provide pixels that maximize antenna gain in the direction at which electromagnetic energy from the scene is sampled. A technical advantage of one embodiment may also include the capability to provide a cold-shielding effect without using temperature control and cooling, which may provide additional benefits such as reduced size, weight, cost, and power requirements. A technical advantage of one embodiment may also include the capability to reduce lens design constraints and improve tolerance of lens interchange due to the elimination of a physical coldshield outside the lens.

Although specific advantages have been disclosed hereinabove, it will be understood that various embodiments may include all, some, or none of the disclosed advantages. Additionally, other technical advantages not specifically cited may become apparent to one of ordinary skill in the art following review of the ensuing drawings and their associated detailed description.

### BRIEF DESCRIPTION OF THE DRAWINGS

A more complete understanding of embodiments of the disclosure will be apparent from the detailed description taken in conjunction with the accompanying drawings in which:

FIGS. 1A and 1B show example antenna-coupled radiation sensors;

FIG. 2A shows a side view of an on-axis pixel on an image plane according to one embodiment;

FIG. 2B shows a side view of an off-axis pixel on an image plane;

FIG. 2C shows a side view of an off-axis pixel on an image plane according to one embodiment;

FIGS. 3A and 3B show an optical imaging view of the pixels of FIGS. 2A and 2C according to one embodiment;

FIGS. 3C and 3D show three-dimensional views of a lens corresponding to FIGS. 3A and 3B according to one embodiment;

FIGS. 4A, 4B, and 4C show a top perspective views of pixels according to one embodiment

FIGS. 4D and 4E show bottom perspective views of pixels according to one example embodiment

FIG. 4F shows the rear feed lines of the pixel of FIG. 4E on a design grid;

FIG. 5A shows an infrared sensor configured to receive incoming rays; and

FIG. 5B shows an infrared sensor configured to receive incoming rays according to one embodiment.

### DETAILED DESCRIPTION OF EXAMPLE EMBODIMENTS

It should be understood at the outset that, although example implementations of embodiments of the invention are illustrated below, the present invention may be implemented using any number of techniques, whether currently known or not. The present invention should in no way be limited to the example implementations, drawings, and techniques illustrated below. Additionally, the drawings are not necessarily drawn to scale.

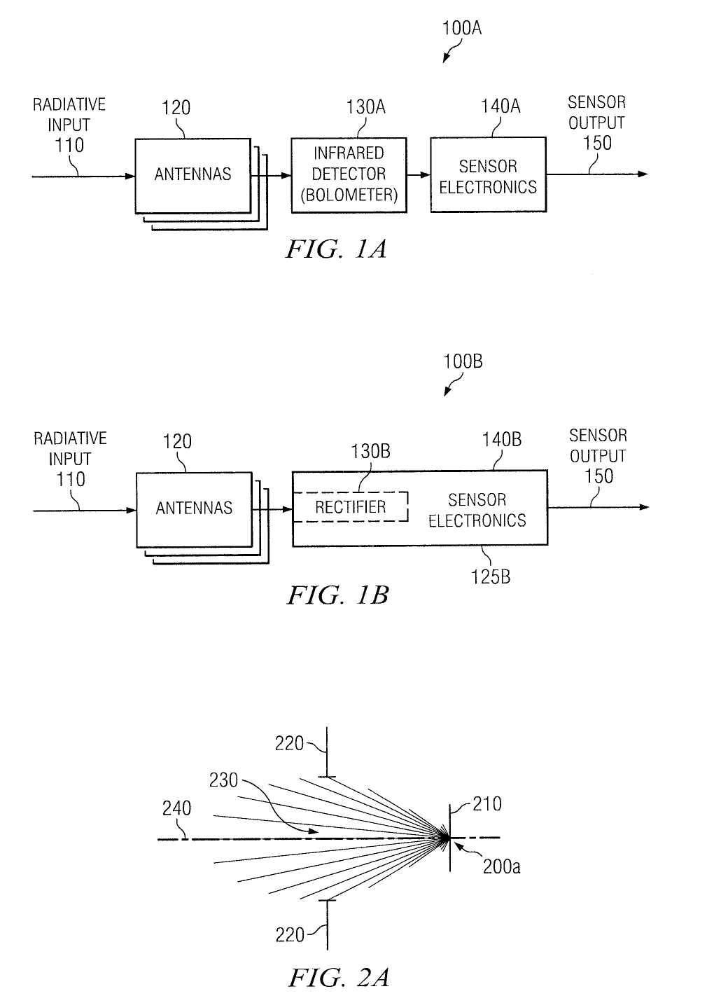

FIGS. 1A and 1B show example antenna-coupled radiation sensors 100A and 100B. Antenna-coupled radiation sensor 100A features one or more antennas 120, an energy detector 130A, and sensor electronics 140A. Antennas 120 may include any device operable to detect radiative input 110. Radiative input 110 may include any electromagnetic energy.

Examples of energy detector 130A may include any device operable to measure detected radiative input 110, such as infrared or high-frequency microwave radiation. Teachings of certain embodiments recognize two separate categories of energy detectors 130A. The first category is rectifiers, such as diode rectifiers. The second category is photodectors, including photovoltaic, photoconductive, and pyroelectric detectors, and example of which is shown in FIG. 1A as energy detector 130A. Photodetectors are operable to measure the power in the flux captured by antennas 120. Examples of a photodetector may include a bolometer or a bandgap or semiconductor detector. An exemplary bolometer measures the energy of electromagnetic radiation in sub-millimeter or infrared wavelengths and operates by sensing the increase in temperature as energy is absorbed. An exemplary bandgap or semiconductor detector operates by generating an electron current or a change in its electrical resistance in proportion to the infrared flux it receives. Materials such as mercury cadmium telluride and indium antimonide may have this characteristic. In both examples, a photodetector is connected to microstrip feed lines from multiple antennas instead of directly to a single antenna element.

Sensor electronics 140A may include any device operable to receive measurements from energy detector 130A and produce a sensor output 150. Sensor electronics 140A may include, but are not limited to, preamplifier and multiplexer circuits.

Antenna-coupled radiation sensor 100B features one or more antennas 120 and electronics 125B. In this example, electronics 125B include a rectifier 130B and sensor electronics 140B. Examples of sensor electronics 140B may include, but are not limited to, preamplifier and multiplexer circuits. In one example, antenna-coupled radiation sensor 100B feeds infrared or microwave waveforms into rectifier 130B, which captures the magnitude of ultra-high frequency infrared or microwave signals and passes that magnitude, then into a preamplifier and multiplexer circuit. In some examples, diode rectifier 130B is a Schottky diode.

Teachings of certain embodiments recognize the capability to use multiple antenna-elements in individual image pixels to increase sensitivity by increasing collection area. For example, antenna dimensions for an imaging system may be smaller than pixel size because diffraction effects create a blur width of 2.44λF, where λ is the wavelength and F is the f-number of the imaging lens. As an example, the diffraction blur limit of F/2 optics is approximately 5 wavelengths, which may be approximately the size of a pixel in some infrared imaging systems. However, teachings of certain embodiments recognize the capability to provide multiple antenna-coupled detectors in a single pixel for shorter and longer wavelengths.

In some embodiments, a radiation sensor may include multiple pixels, each pixel including one or more antenna elements. In these embodiments, pixels may include both on-axis and off-axis pixels. An on-axis pixel is a pixel centered on the optical axis of a lens. An off-axis pixel is a pixel not centered on the optical axis of a lens.

In some embodiments, pixels may be arranged in one-dimensional, two-dimensional, or three-dimensional arrays. For example, in one embodiment, a two-dimensional array has one on-axis pixel centered on or very near the optical axis of a lens and a plurality of off-axis pixels not centered on the optical axis of a lens. In another embodiment, the optical axis of a lens may not align with any pixels, and all of the pixels of an array may be off-axis pixels.

In yet another exemplary embodiment, the alignment of the optical axis and pixels is approximated such that an on-axis pixel is only approximately aligned with the optical axis. For example, an array may actually have multiple pixels located relatively near the optical axis and multiple off-axis pixels located further away from the optical axis.

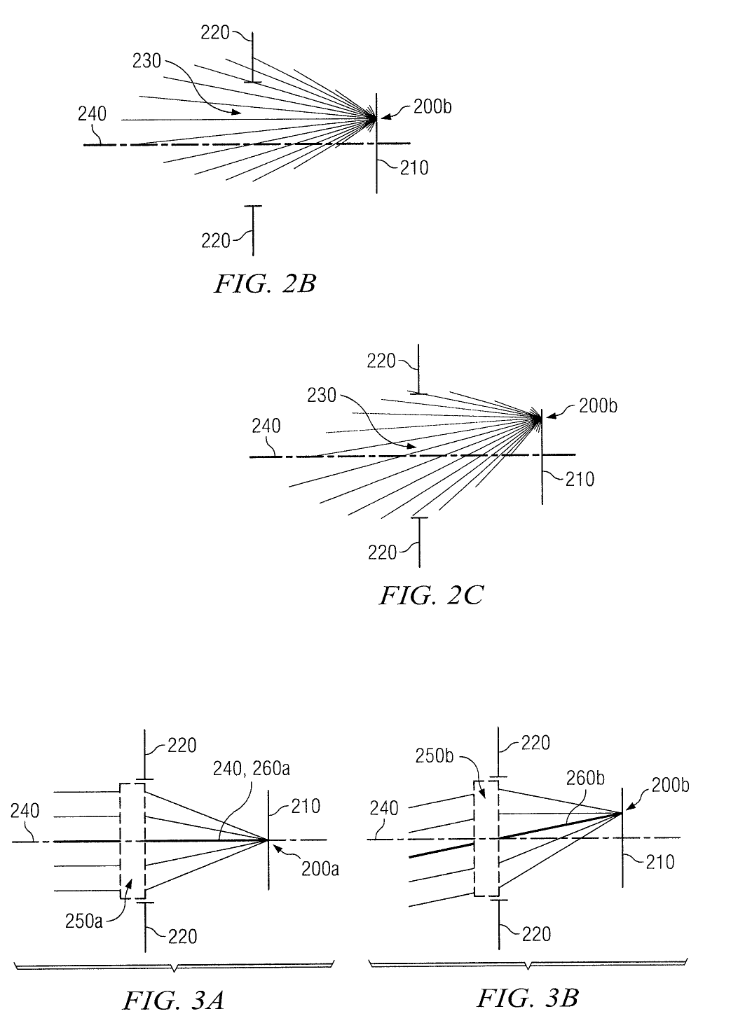

FIG. 2A shows a side view of an on-axis pixel 200a on image plane 210 according to one embodiment. In this example, on-axis pixel 200a is aligned with optical axis 240, which is centered on aperture 230 between barriers 220. Barriers 220 may represent the boundaries of defining aperture 230. Aperture 230 may represent the exit pupil of the imaging lens. A lens for imaging (not shown) may placed in or around aperture 230. Antenna gain is indicated by the lengths of the family of radial lines proximate to on-axis pixel 200a, and the antenna pattern is the envelope defined by the tips of these lines. In this example, maximum sensitivity is perpendicular to image plane 210 and aligned along optical axis 240.

FIG. 2B shows a side view of an off-axis pixel 200b on image plane 210. In this example, off-axis pixel 200b is not aligned with optical axis 240, which is centered on aperture 230 between barriers 220. Antenna gain is indicated by the lengths of the family of radial lines proximate to off-axis pixel 200b, and the antenna gain pattern is the envelope defined by the tips of these lines. In this example, maximum antenna gain at pixel 200b is not aligned along optical axis 240, which decreases antenna sensitivity in the direction of desirable incoming rays through aperture 230.

Accordingly, teachings of certain embodiments recognize the capability to adjust the antenna gain pattern of the antenna array for off-axis pixel 200b. FIG. 2C shows a side view of an off-axis pixel 200b on image plane 210. In this example, off-axis pixel 200b is again offset from optical axis 240, which is centered on aperture 230 between barriers 220. A lens for imaging (not shown) may be placed in or around aperture 230. Aperture 230 may represent the exit pupil of the imaging lens. Antenna gain is indicated by the lengths of the family of radial lines proximate to off-axis pixel 200b, and the antenna pattern is the envelope defined by the tips of these lines. In this example, maximum sensitivity is directed towards the center of aperture 230, increasing antenna sensitivity in the direction of desirable incoming rays through aperture 230.

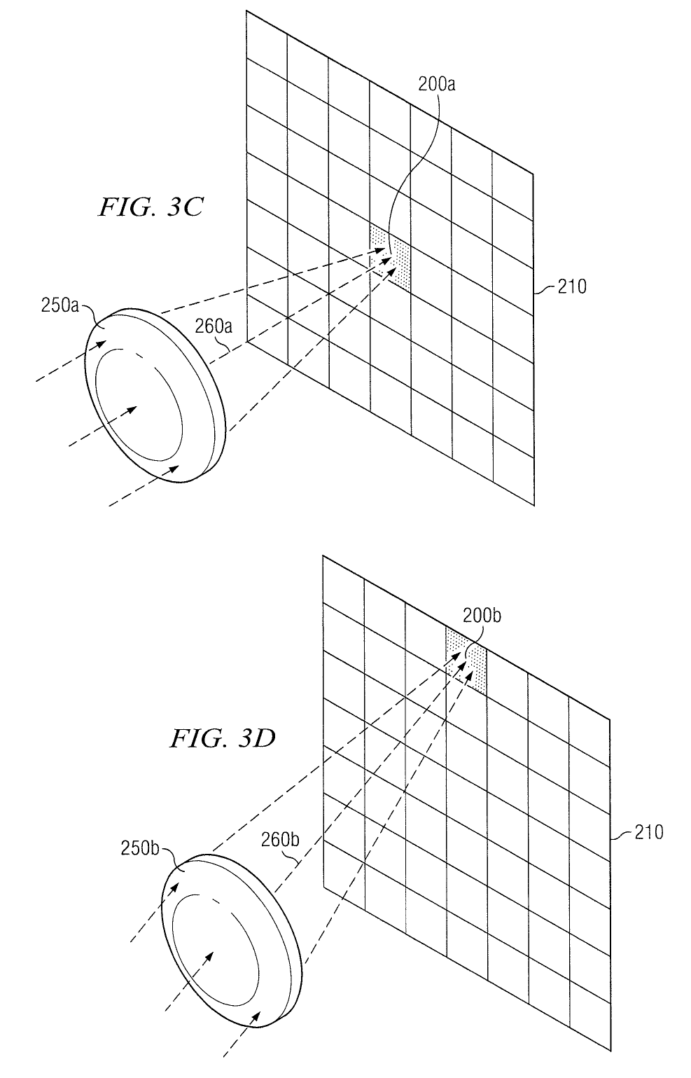

FIGS. 3A and 3B show an optical imaging view of the pixels 200a and 200b of FIGS. 2A and 2C according to one embodiment. FIG. 3A corresponds to FIG. 2A and features a lens 250a and its associated aperture 230 defined by barrier 220. Lens 250a may represent any suitable device for passing electromagnetic radiation. Lens 250a converges individual rays on a point on image plane 210 at on-axis pixel 200a, as shown by the lack of deflection of ray 260a. Ray 260a represents an exemplary incoming ray for illustrative purposes only.

FIG. 3B corresponds to FIG. 2C and features a lens 250b and its associated aperture 230 defined by barrier 220. Lens 250b may represent any suitable device for passing electromagnetic radiation. Lens 250b converges individual rays on a point on image plane 210 at off-axis pixel 200b, as shown by the deflection of ray 260b. Ray 260b represents an exemplary incoming chief ray for illustrative purposes only.

Teachings of certain embodiments recognize the capability to align lens and antenna gain for optimal detection of incoming radiation. For example, FIGS. 2A and 2C show the angles at which antenna gain is sampled, and FIGS. 3A and 3B show the angles at which energy arrives at pixels 200a and 200b. Teachings of certain embodiments recognize that transmitting energy to pixels 200a and 200b in the direction at which maximum antenna gain is sampled.

Teachings of certain embodiments also recognize that reducing antenna gain for angles not subtended by the aperture minimizes detection of flux emanating from sensor internal parts. In this way, a cold-shielding effect may block unwanted flux from hot sensor parts that otherwise would might flood the focal plane and dilute image contrast. Thus, teachings of certain embodiments recognize the capability to provide a cold-shielding effect without using temperature control and cooling, which may provide additional benefits such as reduced size, weight, and power requirements.

FIGS. 3C and 3D show three-dimensional views of lens 250a and 250b according to one embodiment. FIG. 3C corresponds to FIG. 3A and shows a three-dimensional view of lens 250a, and FIG. 3D corresponds to FIG. 3B and shows a three-dimensional view of lens 250b. In these examples, multiple pixels, including on-axis pixel 200a and off-axis pixel 200b, are arranged in an array.

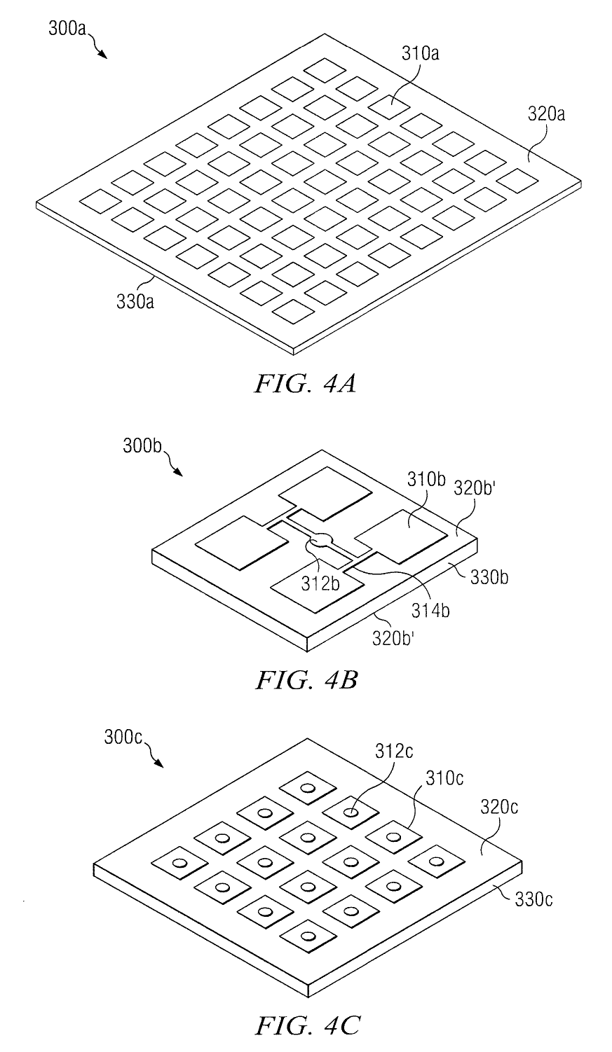

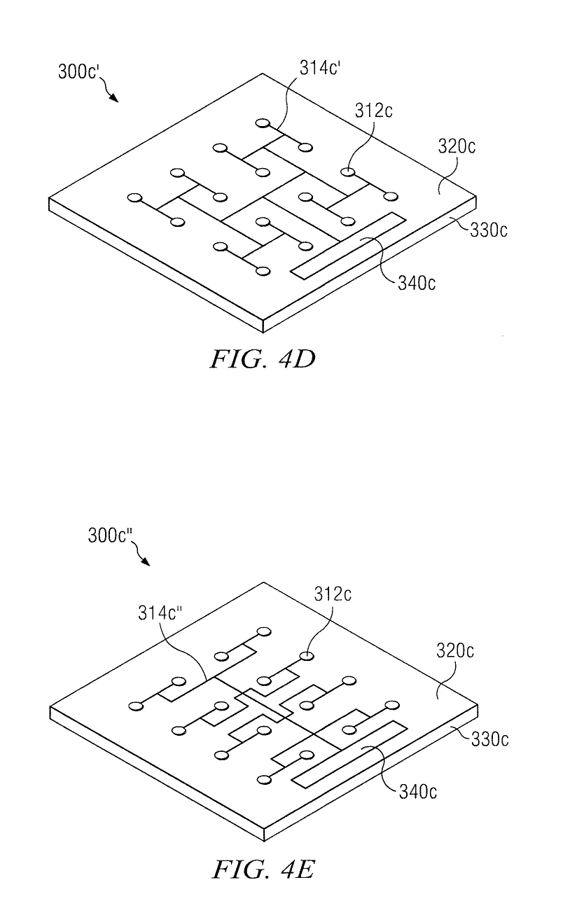

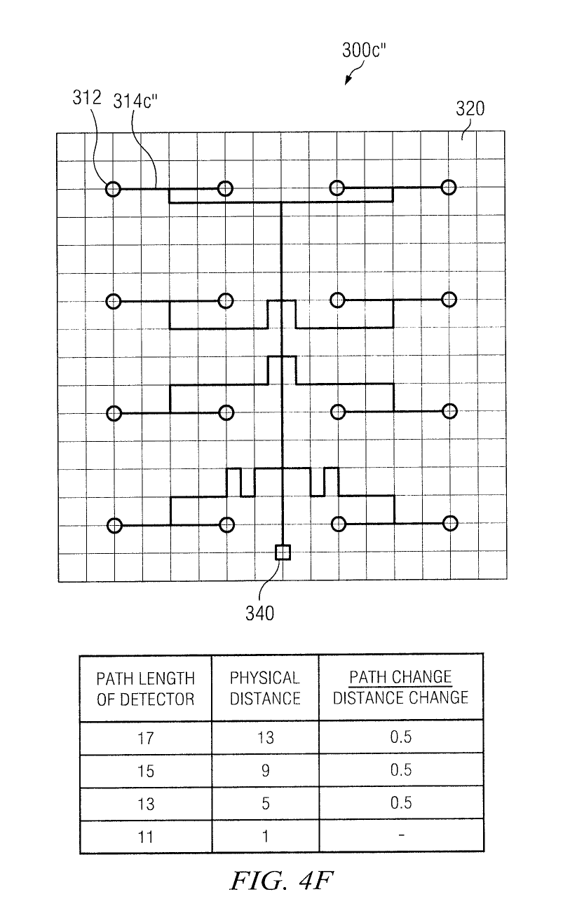

As explained above, teachings of certain embodiments recognize the capability to use multiple antenna-elements in individual image pixels to increase sensitivity by increasing collection area. FIG. 4 shows alternative antenna configurations in a single pixel. Although these configurations show specific numbers of antenna elements and geometries, it is clear that these design principles can be altered to use greater or fewer numbers of elements in different patterns, and achieve the same beneficial results. FIG. 4A shows a top perspective view of a pixel 300a according to one embodiment. Pixel 300a features antenna elements 310a coupled to a ground plane 320a, which is supported by a substrate 330a. In this example, antenna elements 310a are arranged in a two-dimensional array on ground plane 320a.

In some embodiments, antenna elements 310a includes a metalized coating, formed photolithographically, and separated from ground plane 320a by a dielectric coating. In this example, antenna elements 310a are patch shapes. However, antenna elements 310a may be of any suitable shape, including but not limited to rectangular patches, dipoles, folded dipoles, or any element suited to be placed in an array. For example, teachings of certain embodiments recognize that dipoles may be used to detect infrared radiation.

Antenna elements 310a may be dimensioned to any suitable size. For example, dimensions may depend on signal frequency, substrate dielectric, array layout, and other parameters. In this example, the width and length of antenna elements 310a represents one-third of the wavelength of the radiation being sensed. Thus, for 300 GHz microwave sensing, each individual element 300a will be 1 millimeter square; for 2.5 THz thermal sensing (12 micrometer wavelength), each element will be 4 micrometers square. Teachings of certain embodiments recognize that such antenna element sizes are within the capabilities of modern photolithography, which can maintain 0.25 micrometer or smaller dimensional accuracy.

FIG. 4B shows a top perspective view of a pixel 300b according to one embodiment. Pixel 300b features dielectric surfaces 320b on two sides of substrate 330b. In this example, antenna elements 310b are located on one dielectric surface 320b. Front feed lines 314b communicatively couple antenna elements 310b to a feed-through via 312b. Front feed lines 314b may represent any suitable structures for communicatively coupling electrical components, including but not limited to microstrip feed lines. Feed-through via 312b provides a communicative connection between front feed lines 314b and rear feed lines 316b located on the dielectric surface 320b opposite antenna elements 310b. Accordingly, teachings of certain embodiments recognize the capability to increase antenna element density by placing antenna elements on one side of a substrate and electrical connections to the opposite side of the substrate. However, it is clear that the principles of FIG. 4B also apply to a single-sided configuration in which detector 312B is directly connected to front feed lines 314b.

FIG. 4C shows a top perspective view of a pixel 300c according to one embodiment. Pixel 300c features antenna elements 310c coupled to a ground plane 320c, which is supported by a substrate 330c. Pixel 300c does not feature front feed lines 314b. Rather, pixel 300c provides a feed-through via 312c for each antenna element 312c. Teachings of certain embodiments recognize that removing front feed lines 314b may reduce or eliminate the ability of feed lines to adversely interact with antenna functioning and may provide space for more complex feed structures, such as on the rear side of substrate 330c. In this example, feed-through vias are located within antenna elements 310c and communicatively couple antenna elements 310c on one side of substrate 330c to the other side of substrate 330c.

FIG. 4D shows a bottom perspective view of pixel 300c′ according to one example embodiment. In this example embodiment, feed-through vias 312c are coupled to detector-preamplifier 340c through rear feed lines 314c′. In this example, rear feed lines 340c′ couple signals received from antenna elements 310c through feed-through vias 312c into one signal prior to delivering the combined signal to detector 340c. For example, rear feed lines 314c′ may accumulate individual signal contributions from each antenna element 310c and pass the resultant sum to a single detector 340c. This sum may be sensitive to phases of the individual contributions, and the rear feed line 314c′ lengths may be tailored to control the phase of the signal from each antenna element 310c such that the sum is reinforced in a desired angle of arrival and suppressed in undesired angles. Accordingly, teachings of certain embodiments recognize that combining antenna signals before detection may provide a mechanism for tailoring antenna patterns at each pixel. In particular, teachings of certain embodiments recognize the capability to adjust antenna squint or look angle for high-frequency radiation, including but not limited to infrared and high-frequency microwave radiation.

In the exemplary pixel 300c′, rear feed lines 314c′ provide an equal path length between each antenna element 310c and detector 340c. Teachings of certain embodiments recognize that providing an equal path length to each antenna element may optimize antenna gain for incoming rays perpendicular to the antenna plane. For example, the feed-line structure of pixel 300c′ may correspond to the on-axis pixel 200a of FIGS. 2A and 3A.

FIG. 4E shows a bottom perspective view of pixel 300c″ according to one example embodiment. In this example embodiment, feed-through vias 312c are coupled to detector-preamplifier 340c through rear feed lines 314c″.

In this example, rear feed lines 314c″ do not provide an equal path length between each antenna element 310c and detector 340c. Rather, in this example, rear feed lines 314c″ have uniformly different path lengths between antenna elements 310c and detector 340c. This example optimizes incoming rays at a 30-degree angle to the antenna plane. Thus, in this example, the feed-line structure of pixel 300c″ may correspond to the off-axis pixel 200b of FIGS. 2C and 3B.

FIG. 4F shows the rear feed lines 314c″ of pixel 300c″ of FIG. 4E on a design grid. This example embodiment shows the relative lengths of rear feed line 340c″ for illustrative purposes only. Thus, although in this example embodiment the relative lengths optimize incoming rays at a 30-degree angle to the antenna plane, in other embodiments the illustrated feed-line lengths may produce a different result. As stated elsewhere, antenna patterns may be controlled by dimensions of the antenna and antenna feed structures, as well as other design parameters.

In this example, the length of rear feed lines 314c″ to each antenna element 310c increases two grid spaces moving away from detector 340c, whereas actual distance increases four grid spaces. In this example, increasing the length of rear feed lines 314c″ in this manner creates a squint of 30 degrees in one plane. Similar teachings may be applied to create squint angles in two planes and/or three planes.

In these examples of pixel 300c′ and 300c″, antenna sensitivity as a function of direction is fixed by the design of antenna feed lines within the antenna array of the pixel. Teachings of certain embodiments recognize that delineation of feed lines may be accomplished through any suitable method, including but not limited to photolithography, such as done in fabrication of integrated circuit chips. Teachings of certain embodiments also show that realization of these desired feed line lengths in practical hardware may require consideration of additional well-understood design parameters like transmission line losses and propagation velocity, particularly for wavelengths as short as mid-wave infrared. Consequently, design and shape of feed-length dimensions may need to consider such detailed effects as the microstrip spacing from the ground plane, the dielectric constant of the insulating substrate, the microstrip line width and thickness, and the inductance and capacitance of the feed-line patterns. In addition, teachings of certain embodiments recognize that the front-face feed structure of FIG. 4B may result in shorter feed-line lengths than the rear-face feed structure of FIGS. 4C, 4D, and 4E. On the other hand, teachings of certain embodiments recognize that the rear-face feed structure illustrated in FIGS. 4C, 4D, and 4E better isolates the feed and antenna structures, thus may improve antenna performance. These details of design are well known to radar antenna designers.

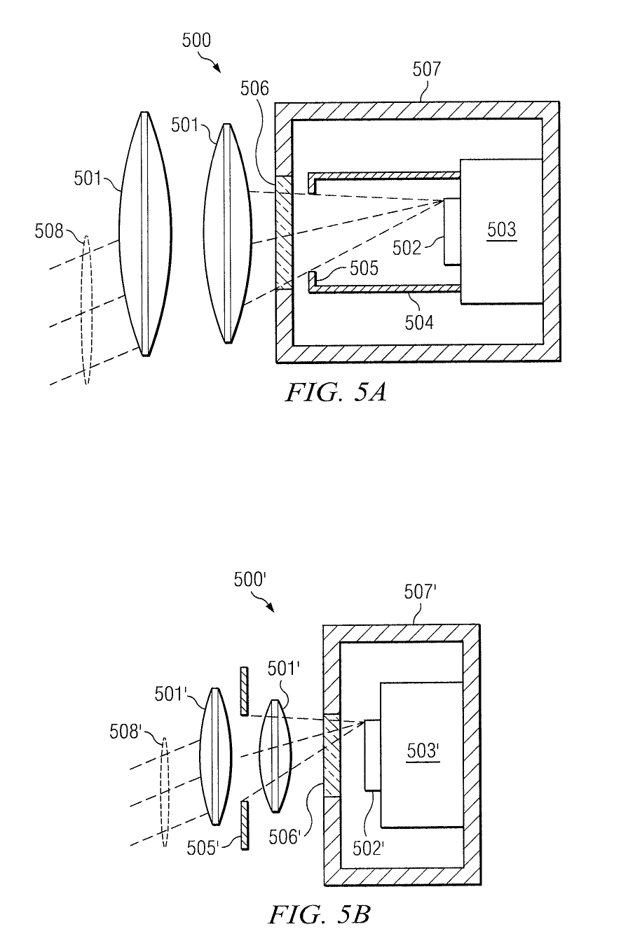

FIG. 5A shows infrared sensor 500 configured to receive incoming rays 508. Infrared sensor 500 features one or more lenses 501, a detector 502, a cooler 503, a coldshield 504, a stop 505, a window 506, and an enclosure 507. In the illustrated embodiment, external lens 501 creates a scene image on detector array 502 that is mounted on a cryogenic cooler 503. Coldshield 504 is mounted atop the cooler, on the detector platform or at some other attachment point that provides conductive cooling. Optical stop 505 allows radiation within its subtense to pass to the detector, while radiation at other angles is blocked or masked by coldshield 504. Due to its cold temperature, there is insignificant radiation from the interior of coldshield 504 itself. Window 506 admits flux from the lens into sealed enclosure 507. Such enclosures are commonly used in cryogenic sensors to block conductive thermal transfer into, and condensation and frosting onto, the cold parts. The size of window 506 and lens 501 is large enough to pass the extreme ray angles from the edge of detector array 502. FIG. 5A is not drawn to scale or with the complexity of a typical sensor design.

Teachings of certain embodiments recognize the capability to reduce or eliminate the need for a coldshield, such as coldshield 504. Accordingly, FIG. 5B shows infrared sensor 500′ configured to receive incoming rays 508′ according to one embodiment. Infrared sensor 500′ features one or more lenses 501′, a detector 502′, a cooler 503′, a stop 505′, a window 506′, and an enclosure 507′.

In the illustrated embodiment, external lens 501′ creates a scene image on detector array 502′ that is mounted on a cryogenic cooler 503, as before. Coldshield 504′ (not shown) is greatly reduced in size, and is used primarily to block radiative heatload on the cold parts. Optical stop 505′ is located within the optics, rather than within the cryogenic package. Window 506′ is closer to detector 502′, since no space is required for the coldshield. Lens 501′ is smaller, since it is located closer to detector array 502′, and since it is more symmetrically disposed about optical stop 505′. FIG. 5B is not drawn to scale or with the complexity of a typical sensor design.

Comparing FIGS. 5A and 5B, the smaller optics in FIG. 5B are notable. The off-axis angles of detector elements at the edge of the detector array cause optics size to increase in proportion to distance between the lens and detector, due to obvious geometry. Hence, moving the lens closer may reduce the size of the lens elements nearest the detector. In addition, for compact optics that do not reimage the stop, the cone of all imaging rays generally diverges in proportion to the distance from the stop; hence, placing the stop inside the lens reduces the size of lens elements closer to the scene (further from the detector). Teachings of certain embodiments recognize that these two effects may combine so as to reduce the overall lens size, which in turn reduces sensor size and weight.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic. As used in this document, “each” refers to each member of a set or each member of a subset of a set.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke paragraph 6 of 35 U.S.C. §12 as it exists on the date of filing hereof unless the words “means for” or “step for” are explicitly used in the particular claim.

What is claimed is:

1. A radiation sensor comprising:
a first pixel, the first pixel comprising a first plurality of antenna elements, a first photodetector, and one or more first feed lines coupling the first plurality of antenna elements to the first photodetector; and
a second pixel, the second pixel comprising a second plurality of antenna elements, a second photodetector, and one or more second feed lines coupling the second plurality of antenna elements to the second photodetector, wherein:
the second pixel is an off-axis pixel, and
signals feeding each of the second plurality of antenna elements are varied such that an effective radiation pattern of the second plurality of antenna elements is reinforced in a desired direction and suppressed in an undesired direction.

2. The radiation sensor of claim 1, wherein the second one or more feed lines accumulate signal contributions from each of the plurality of antenna elements prior to communicating the accumulated signal contributions to the second photodetector.

3. The radiation sensor of claim 1, wherein each of the first plurality of antenna elements has an equal length across the one or more first feed lines to the first photodetector.

4. The radiation sensor of claim 1, wherein at least two of the second plurality of antenna elements have different lengths across the one or more second feed lines to the second photodetector.

5. The radiation sensor of claim 1, further comprising an optical lens operable to focus received radiation on a focal point corresponding to the second plurality of antenna elements.

6. The radiation sensor of claim 5, wherein the received radiation is infrared radiation.

7. The radiation sensor of claim 5, wherein the received radiation is microwave radiation.

8. A method of detecting radiation, comprising:
receiving radiation at a first pixel and a second pixel, wherein:
the first pixel comprises a first plurality of antenna elements, a first photodetector, and one or more first feed lines coupling the first plurality of antenna elements to the first photodetector,
the second pixel comprises a second plurality of antenna elements, a second photodetector, and one or more second feed lines coupling the second plurality of antenna elements to the second photodetector,
the second pixel is an off-axis pixel, and
signals feeding each of the second plurality of antenna elements are varied such that an effective radiation pattern of the second plurality of antenna elements is reinforced in a desired direction and suppressed in an undesired direction;
communicating accumulated signal contributions from each of the first plurality of antenna elements to the first photodetector; and
communicating accumulated signal contributions from each of the second plurality of antenna elements to the second photodetector.

9. The method of claim 8, wherein each of the first plurality of antenna elements has an equal length across the one or more first feed lines to the first photodetector.

10. The method of claim 8, wherein at least two of the second plurality of antenna elements have different lengths across the one or more second feed lines to the second photodetector.

11. The method of claim 8, further comprising an optical lens operable to focus the received radiation on a focal point corresponding to the second plurality of antenna elements.

12. The method of claim 8, wherein the received radiation is infrared radiation.

13. The method of claim 8, wherein the received radiation is microwave radiation.

14. A radiation sensor pixel comprising:
a plurality of antenna elements;
a photodetector;
one or more feed lines coupling the plurality of antenna elements to the photodetector, wherein the one or more feed lines accumulate signal contributions from each of the plurality of antenna elements prior to communicating the accumulated signal contributions to the photodetector.

15. The radiation sensor of claim 14, wherein signals feeding each of the plurality of antenna elements are varied such that an effective radiation pattern of the plurality of antenna elements is reinforced in a desired direction and suppressed in an undesired direction.

16. The radiation sensor of claim 14, wherein each of the plurality of antenna elements has an equal length across the one or more feed lines to the photodetector.

17. The radiation sensor of claim 14, wherein at least two of the plurality of antenna elements have different lengths across the one or more feed lines to the photodetector.

18. The radiation sensor of claim 14, further comprising an optical lens operable to focus received radiation on a focal point corresponding to the plurality of antenna elements.

19. The radiation sensor of claim 18, wherein the received radiation is infrared radiation.

20. The radiation sensor of claim 18, wherein the received radiation is microwave radiation.
